(19) United States
(12) Patent Application Publication
(10) Pub. No.: US 2020/0198046 A1
(43) Pub. Date: Jun. 25, 2020

(54) ADDITIVE MANUFACTURING METHOD AND ADDITIVE MANUFACTURING DEVICE

(71) Applicant: MITSUBISHI HEAVY INDUSTRIES, LTD., Tokyo (JP)

(72) Inventors: Yoto IMAIZUMI, Tokyo (JP); Yasuyuki FUJIYA, Tokyo (JP); Ken ISHII, Tokyo (JP); Hiroki KOMURO, Tokyo (JP); Akiko INOUE, Tokyo (JP); Shintaro KIMURA, Tokyo (JP)

(21) Appl. No.: 16/636,722

(22) PCT Filed: Mar. 6, 2019
(86) PCT No.: PCT/JP2019/008799

§ 371 Date: Feb. 5, 2020

(30) Foreign Application Priority Data
Mar. 9, 2018 (JP) 2018-042689

(51) Int. Cl. B23K 20/12; B22F 3/105

(52) U.S. Cl. CPC B23K 20/12; B33Y 10/00; B22F 3/105

(57) ABSTRACT

An additive manufacturing method for performing additive manufacturing of a metallic powder material on a surface of a metallic base material includes a step of supplying the powder material onto the surface of the base material, a step of welding the powder material to the surface in an unmelted state through friction stir of the powder material and the surface, a step of supplying the powder material onto a welded portion formed by welding the powder material to the surface, and a step of welding the powder material to the welded portion in the unmelted state through friction stir of the powder material and the welded portion.

### TECHNICAL FIELD

The present disclosure relates to an additive manufacturing method and an additive manufacturing device for additive manufacturing a metallic powder material on a metallic lamination plane.

### BACKGROUND

As conventional 3D modeling technologies, laser melting (SLM) which is good at modeling a complicated microstructure, and a Laser Metal Deposition (LMD) which is capable of high-speed/local modeling without any dimensional constraint are given. However, each of the conventional technologies performs modeling by melting a material, and thus has difficulty being applied to a material which has a large deformation amount and cannot be melted or a material where a defect is likely to occur (for example, 2,000 series aluminum or the like).

On the other hand, although not a modeling technology but a welding technology, Friction Stir Welding (FSW) is known, which can weld members to each other without melting a welded portion. FSW is a method of inserting an apical protrusion of a cylindrical tool into a welded portion of members to be welded while rotating the tool to soften the members by friction heat, and welding the members to each other by causing plastic flow and mixing on the periphery of the welded portion by a rotational force of the tool. The invention related to such FSW is described in, for example, Patent Documents 1 and 2.

### CITATION LIST

### Patent Literature

Patent Document 1: US Patent Application Publication No. 2017/0043429

Patent Document 2: JP3735296B

### SUMMARY

### Technical Problem

As a result of intensive researches by the present inventors, it became clear that additive manufacturing is possible without melting a material by using the principle of FSW. None of Patent Documents 1 and 2 describes that additive manufacturing is possible by using the principle of FSW.

In view of the above, an object of at least one embodiment of the present disclosure is to provide an additive manufacturing method and an additive manufacturing device enabling additive manufacturing without melting a material.

### Solution to Problem

An additive manufacturing method according to at least one embodiment of the present disclosure is an additive manufacturing method for performing additive manufacturing of a metallic powder material on a surface of a metallic base material, the additive manufacturing method including a step of supplying the powder material onto the surface of the base material, a step of welding the powder material to the surface in an unmelted state through friction stir of the powder material and the surface, a step of supplying the powder material onto a welded portion formed by welding the powder material to the surface, and a step of welding the powder material to the welded portion in the unmelted state through friction stir of the powder material and the welded portion.

With the above method, since it is possible to weld the powder material to the welded portion in the unmelted state after forming the welded portion by welding the powder material to the surface of the metallic base material in the unmelted state, additive manufacturing is possible without melting the material.

In some embodiments, the powder material may be welded to the surface to perform additive manufacturing of an additive manufactured object of a three-dimensional shape protruding with respect to the surface.

In some embodiments, the powder material may be welded onto the welded portion through friction stir of the powder material and the welded portion while supplying the powder material to the welded portion.

In some embodiments, the additive manufacturing method may further include a step of preparing a rotatable rotating tool before the step of welding the powder material to the surface. The rotating tool may include a tip surface where a recessed surface is formed, a holding space defined by the recessed surface, and a communication portion making the holding space and an exterior of the rotating tool communicate with each other. Friction stir may be made by rotating the rotating tool while allowing the powder material to flow into the holding space via the communication portion.

In some embodiments, the additive manufacturing method may further include a step of preparing a guide member surrounding the rotating tool along a rotational direction of the rotating tool after the step of preparing the rotating tool.

In some embodiments, the additive manufacturing method may further include a step of preparing a supply member for supplying the powder material before the step of supplying the powder material onto the surface of the base material. The powder material may be supplied into the guide member by the supply member.

In some embodiments, the metal may include aluminum, an aluminum alloy, a nickel-based alloy, an iron-based material, a titanium alloy, a copper alloy, stainless steel, or Inconel.

An additive manufacturing device according to at least one embodiment of the present disclosure is an additive manufacturing device for performing additive manufacturing of a metallic powder material on a metallic lamination plane, the additive manufacturing device including a rotatable rotating tool. The rotating tool includes a tip surface where a recessed surface is formed, and a pin disposed so as to protrude more than a part of the tip surface protruding most from the recessed surface.

With the above configuration, since it is possible to frictionally stir the powder material while holding the powder material in the holding space which is defined by the recessed surface formed on the tip surface, it is possible to reduce the powder material dispersed around the rotating tool without being frictionally stirred and to frictionally stir the powder material by the rotating tool reliably.

In some embodiments, the rotating tool may form a communication portion making a holding space and an exterior of the rotating tool communicate with each other, the holding space being defined by the recessed surface.

With the above configuration, since the powder material enters the holding space via the communication portion when the additive manufacturing device is moved along the powder material supplied onto the lamination plane, it is possible to easily introduce the powder material into the holding space.

In some embodiments, on the tip surface, a scroll groove of a scroll shape may be formed, the scroll groove extending in a direction toward an outer circumferential edge of the tip surface along a rotational direction of the rotating tool.

With the above configuration, since the powder material moves toward the center of the tip surface along the scroll groove along with the rotation of the rotating tool, stir of the powder material in the holding space is promoted, making it possible to enhance the effect of friction stir of the powder material.

In some embodiments, the additive manufacturing device may further include a supply member supplying the powder material onto the lamination plane.

With the above configuration, since it is possible to frictionally stir the powder material while supplying the powder material onto the lamination plane, it is possible to efficiently perform additive manufacturing as compared with a case in which the power material is frictionally stirred after being supplied onto the lamination plane.

An additive manufacturing device according to at least one embodiment of the present disclosure is an additive manufacturing device for performing additive manufacturing of a metallic powder material on a metallic lamination plane, the additive manufacturing device including a rotatable rotating tool including a tip surface and a pin protruding from the tip surface, and a guide member surrounding the rotating tool along a rotational direction of the rotating tool.

With the above configuration, since it is possible to reduce, with the guide member, the powder material dispersed around the rotating tool without being frictionally stirred, the rotating tool can frictionally stir the powder material reliably.

In some embodiments, the rotating tool may have an outer surface of a columnar shape where a spiral groove of a spiral shape is formed, the spiral groove extending in a direction distanced from the tip surface along the rotational direction of the rotating tool.

With the above configuration, since the powder material between the inner circumferential surface of the guide member and the outer surface of the rotating tool moves toward the tip surface along the spiral groove along with the rotation of the rotating tool, and easily enters between the tip surface and the lamination plane, the rotating tool can frictionally stir the powder material reliably.

In some embodiments, the guide member may have a first edge facing the lamination plane and a second edge opposing the first edge, and in the guide member, a cut-out portion cut out from the first edge toward the second edge may be formed.

With the above configuration, since the welded portion formed by welding the powder material to the lamination plane passes through the cut-out portion when the additive manufacturing device moves, it is possible to smoothly move the additive manufacturing device by preventing the guide member from being caught in the welded portion.

In some embodiments, in the guide member, a flow passage for flowing a cooling fluid may be formed.

With the above configuration, since the guide member is cooled by the cooling fluid during friction stir, it is possible to reduce seizure between the rotating tool and the guide member.

In some embodiments, the additive manufacturing device may further include a supply member for supplying the powder material into the guide member.

With the above configuration, since it is possible to frictionally stir the powder material while supplying the powder material onto the lamination plane, it is possible to efficiently perform additive manufacturing as compared with the case in which the powder material is frictionally stirred after being supplied onto the lamination plane.

In some embodiments, a thread groove may be formed in an outer peripheral surface of the pin, the thread groove extending from a base toward a tip of the pin along a rotational direction of the rotating tool.

With the above configuration, since the powder material moves from the tip toward the base of the pin along the thread groove when the powder material is frictionally stirred, stir of the powder material is promoted, making it possible to enhance the effect of friction stir of the powder material.

### Advantageous Effects

According to at least one embodiment of the present disclosure, it is possible to weld a powder material to a welded portion in an unmelted state after forming the welded portion by welding the powder material to the surface of a metallic base material in the unmelted state, making it possible to perform additive manufacturing without melting the material.

### BRIEF DESCRIPTION OF DRAWINGS

FIG. 1 is a schematic view showing the configuration of an additive manufacturing device according to Embodiment 1 of the present disclosure.

FIG. 2 is a view for describing an additive manufacturing method by the additive manufacturing device according to Embodiment 1 of the present disclosure.

FIG. 3 is a view for describing a mechanism for welding a powder material to a lamination plane by friction stir.

FIG. 4 is a schematic cross-sectional view showing the configuration of a rotating tool of the additive manufacturing device according to Embodiment 2 of the present disclosure.

FIG. 5 is a bottom view of the rotating tool of the additive manufacturing device according to Embodiment 2 of the present disclosure.

FIG. 6 is a view for describing a mechanism for welding the powder material to the lamination plane by friction stir using the rotating tool of the additive manufacturing device according to Embodiment 2 of the present disclosure.

FIG. 7 is a cross-sectional view showing a modified example of a recessed surface formed in a tip surface of the rotating tool of the additive manufacturing device according to Embodiment 2 of the present disclosure.

FIG. 8 is a cross-sectional view showing another modified example of the recessed surface formed in the tip surface of the rotating tool of the additive manufacturing device according to Embodiment 2 of the present disclosure.

FIG. 9 is a schematic view showing the configuration of the additive manufacturing device according to Embodiment 3 of the present disclosure.

FIG. 10 is a schematic front view showing the configuration of the rotating tool of the additive manufacturing device according to Embodiment 2 of the present disclosure.

FIG. 11 is a perspective view showing the configuration of a guide member of the additive manufacturing device according to Embodiment 2 of the present disclosure.

### DETAILED DESCRIPTION

Embodiments of the present invention will now be described in detail with reference to the accompanying drawings. However, the scope of the present invention is not limited to the following embodiments. It is intended that dimensions, materials, shapes, relative positions and the like of components described in the embodiments shall be interpreted as illustrative only and not intended to limit the scope of the present invention.

### Embodiment 1

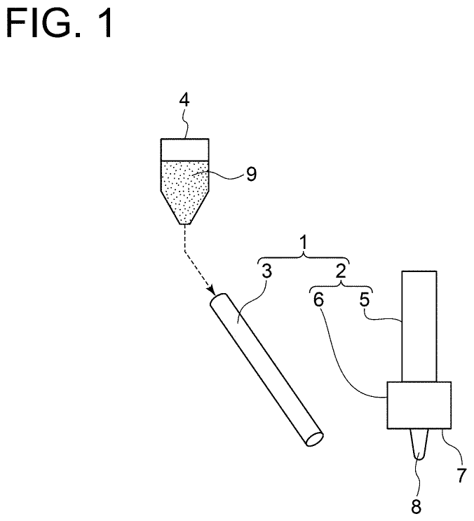

As shown in FIG. 1, an additive manufacturing device 1 according to Embodiment 1 includes a rotating tool 2 disposed to be rotatable and a powder supply nozzle 3 which is a supply member supplying a metallic powder material 9. The powder supply nozzle 3 communicates with a storage portion 4 storing the powder material 9. Supply of the powder material 9 from the storage portion 4 to the powder supply nozzle 3 may utilize the self-weight of the powder material 9, or may utilize a feeder or the like (not shown).

The rotating tool 2 includes a grip portion 5 and a friction stir portion 6. The grip portion 5 is to be gripped by a rotating device (not shown) for rotating the rotating tool 2. The friction stir portion 6 has a flat tip surface 7 contacting the powder material 9 and frictionally stirring the powder material 9. On the tip surface 7, a pin 8 is disposed so as to protrude from the tip surface 7.

Next, an additive manufacturing method using the additive manufacturing device 1 according to Embodiment 1 will be described.

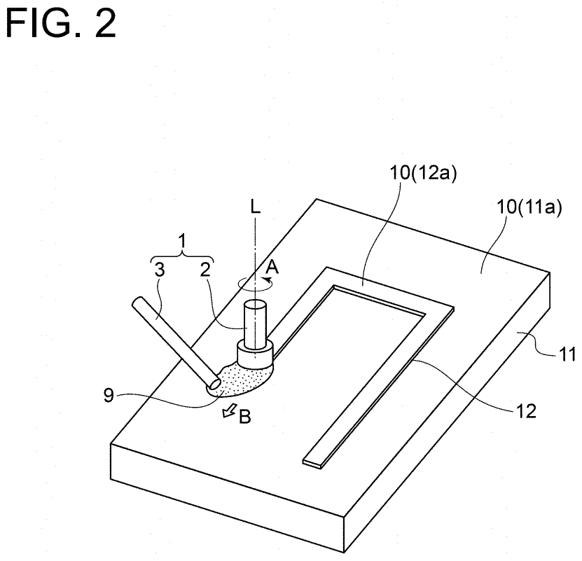

In Embodiment 1, as shown in FIG. 2, the additive manufacturing device 1 performs additive manufacturing of the powder material 9 on a metallic lamination plane 10, that is, on a surface 11a of a metallic base material 11. Metals constituting the powder material 9 and the base material 11 may be the same or different. Available metals are general metals including aluminum, a nickel-based alloy, and an iron-based material. In addition, as the available metals, an aluminum alloy, a titanium alloy, a copper alloy, stainless steel, Inconel, or the like can also be given.

During additive manufacturing by the additive manufacturing device 1, the rotating tool 2 moves in parallel to the surface 11a of the base material 11 while rotating about its rotational axis L in the direction of an arrow A. The moving direction is indicated by an arrow B. The powder material 9 is supplied onto the surface 11a from the powder supply nozzle 3 immediately before the rotating tool 2 in the moving direction B. If the rotating tool 2 moves in the moving direction B, the powder material 9 is interposed between the surface 11a and the tip surface 7 of the rotating tool 2 (see FIG. 1). The rotating tool 2 applies a pressure to the powder material 9 while rotating in the direction of the arrow A, thereby frictionally stirring the powder material 9.

The rotation speed of the rotating tool 2 and the movement speed of the rotating tool 2 (or may be restated as the movement speed of the powder supply nozzle 3) can respectively be changed as needed in accordance with the type of metal to be used or other conditions. For example, if each of the base material 11 and the powder material 9 is constituted by the aluminum alloy, the rotation speed can be 150 to 400 rpm, or more preferably 250 to 400 rpm, and the movement speed can be 5 to 15 inches per minute, or more preferably 7 to 14 inches per minute.

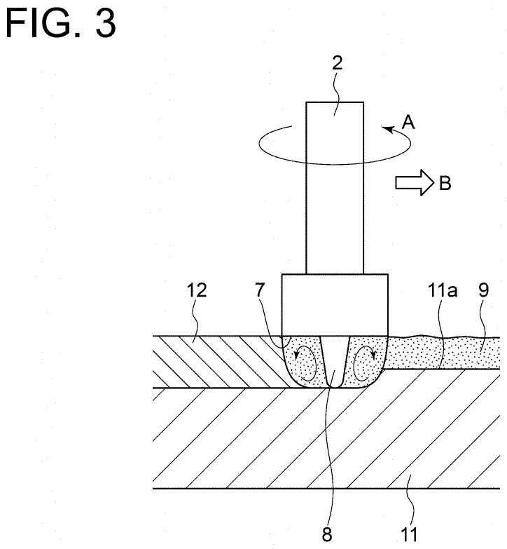

As shown in FIG. 3, since the pin 8 also rotates along with the rotation of the rotating tool 2, the pin 8 rotates while abutting on a portion of the surface 11a covered with the powder material 9. That is, the pin 8 frictionally stirs the portion of the surface 11a covered with the powder material 9. Then, due to friction heat and a pressure generated in an abutting portion between the pin 8 and the surface 11a, the metal constituting the base material 11 undergoes plastic flow. On the other hand, the powder material 9 also undergoes plastic flow due to friction stir by the tip surface 7. The metals of the base material 11 and the powder material 9 which have undergone plastic flow are mixed together.

Since the rotating tool 2 moves in the moving direction B, the metals which have undergone plastic flow lose the friction heat to be cooled and cured rapidly on the rear side of the rotating tool 2 in the moving direction B. Consequently, the metals of the base material 11 and the powder material 9 which have undergone plastic flow are welded while being mixed together and wholly integrated with each other, forming a welded portion 12 on the surface 11a. Since a temperature at which the metals undergo plastic flow is much lower than a melting point, the weld between the base material 11 and the powder material 9 falls into the category of solid-state welding. That is, the weld between the base material 11 and the powder material 9 is performed in an unmelted state. Thus, a heat input amount to the metals is small throughout a welding process, and a stress associated with solidification contraction does not occur, hardly causing deformation and a crack due to thermal distortion in the vicinity of the welded portion 12.

As shown in FIG. 2, the welded portion 12 is formed on the surface 11a, and then the pin 8 (see FIG. 1) frictionally stirs the welded portion 12 as the tip surface 7 frictionally stirs the powder material 9 while supplying the powder material 9 to the welded portion 12, thereby welding the powder material 9 onto the welded portion 12 in the unmelted state. If the powder material 9 is welded to the welded portion 12, the lamination plane 10 becomes a surface 12a of the welded portion 12. Repeating the operation, the welded portion 12, that is, an additive manufactured object of an arbitrary three-dimensional shape is formed on the surface 11a.

Thus, it is possible to weld the powder material 9 to the lamination plane 10 in the unmelted state by frictionally stirring the metallic powder material 9 and the metallic lamination plane 10, enabling additive manufacturing without melting the material.

### Embodiment 2

Next, an additive manufacturing device and an additive manufacturing method according to Embodiment 2 will be described. The additive manufacturing device and the additive manufacturing method according to Embodiment 2 are obtained by modifying Embodiment 1 in terms of the configuration of the rotating tool 2. In Embodiment 2, the same constituent elements as those in Embodiment 1 are associated with the same reference numerals and not described again in detail.

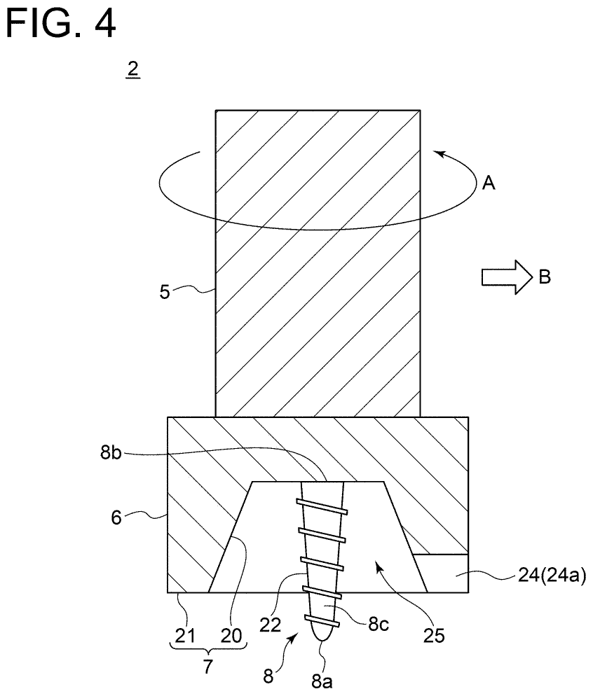

As shown in FIG. 4, in Embodiment 2, the tip surface 7 of the friction stir portion 6 in the rotating tool 2 includes a recessed surface 20 and a flat surface 21 of an annular shape formed so as to surround the recessed surface 20. The recessed surface 20 defines a holding space 25 of a cone shape. Further, the pin 8 is disposed on the tip surface 7. The pin 8 has a base 8b positioned on the recessed surface 20 and a tip 8a which protrudes more than a part of the tip surface 7 protruding most from the recessed surface 20, that is, protrudes more than the flat surface 21.

Although not an essential component in Embodiment 2, a communication portion 24 making the holding space 25 and the exterior of the rotating tool 2 communicate with each other may be formed in the friction stir portion 6. The communication portion 24 can be, for example, a slit 24a cut out from the flat surface 21 along the length direction of the rotating tool 2. The width, the length, the number, and the like of the slit 24a can arbitrarily be determined. Alternatively, the communication portion 24 may be a through hole penetrating the friction stir portion 6. If the communication portion 24 is the through hole, the shape, the opening area, the number, and the like of the through hole can arbitrarily be determined.

Although not an essential component in Embodiment 2, a thread groove 22 may be formed on in an outer peripheral surface 8c of the pin 8. The thread groove 22 is preferably formed so as to extend from the base 8b toward the tip 8a of the pin 8 along the rotational direction A of the rotating tool 2.

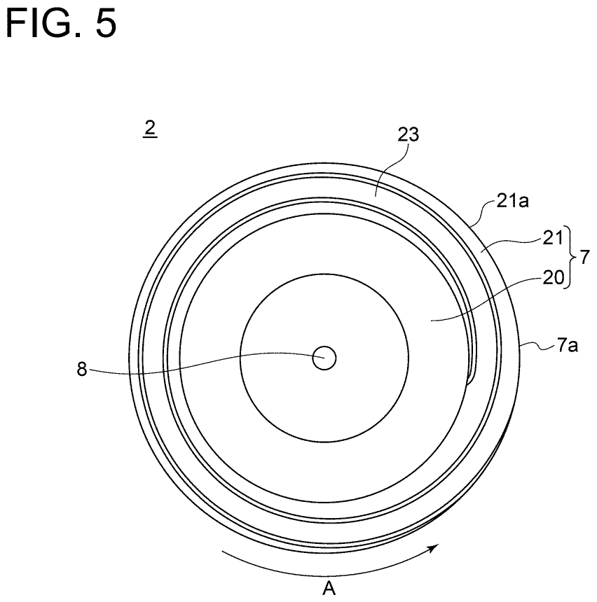

Although not an essential component in Embodiment 2, a scroll groove 23 of a scroll shape may be formed in the flat surface 21, as shown in FIG. 5. The scroll groove 23 is preferably formed so as to extend in a direction toward an outer circumferential edge 7a of the tip surface 7 along the rotational direction A of the rotating tool 2, or in other words, a direction toward an outer circumferential edge 21a of the flat surface 21 in Embodiment 2. The scroll groove 23 can be made by forming a recess, that is, a groove extending in a scroll shape in the flat surface 21 or may be made by attaching a member extending in a scroll shape so as to protrude from the flat surface 21. The scroll groove 23 is not limited to be formed only in the flat surface 21 but may be formed in the recessed surface 20 continuously from the flat surface 21.

Other configurations are the same as Embodiment 1.

In Embodiment 2, the principle that the powder material 9 (see FIG. 1) is welded to the lamination plane 10 (see FIG. 1) and the basic part of the additive manufacturing method by the additive manufacturing device 1 are the same as Embodiment 1. Thus, an operation regarding constituent elements included only by the additive manufacturing device 1 of Embodiment 2 and an effect obtained therefrom will be described below.

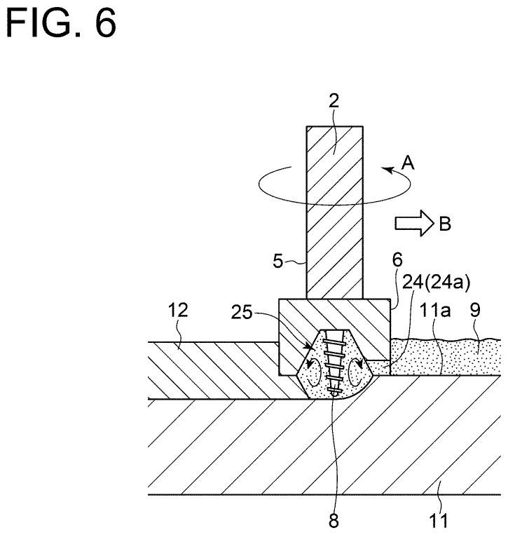

As shown in FIG. 6, if the rotating tool 2 moves in the direction of the arrow B while rotating in the direction of the arrow A, the slit 24a periodically faces the direction of the arrow B. When the slit 24a faces the direction of the arrow B, the powder material 9 (see FIG. 1) enters the holding space 25 via the slit 24a, making it possible to easily introduce the powder material 9 into the holding space 25. In addition, by holding the powder material 9 introduced into the holding space 25, it is possible to reduce the powder material 9 dispersed around the rotating tool 2 without being frictionally stirred. Thus, the rotating tool 2 can frictionally stir the powder material 9 reliably.

As shown in FIG. 4, if the thread groove 22 is formed in the outer peripheral surface 8c of the pin 8, the powder material 9 in the holding space 25 moves along the thread groove 22 along with the rotation of the rotating tool 2 in the direction of the arrow A. If the thread groove 22 is formed so as to extend from the base 8b toward the tip 8a of the pin 8 along the rotational direction A of the rotating tool 2, the powder material 9 moves from the tip 8a toward the base 8b of the pin 8 along the thread groove 22. As a result, stir of the powder material 9 in the holding space 25 is promoted, making it possible to enhance the effect of friction stir of the powder material 9.

As shown in FIG. 5, if the scroll groove 23 is formed in the flat surface 21, the powder material 9 moves along the scroll groove 23 along with the rotation of the rotating tool 2 in the direction of the arrow A. If the scroll groove 23 extends in the direction toward the outer circumferential edge 21a of the flat surface 21 along the rotational direction A of the rotating tool 2, the powder material 9 moves toward the holding space 25 to be introduced into the holding space 25 and is frictionally stirred in the holding space 25. If the scroll groove 23 is formed not only in the flat surface 21 but also in the recessed surface 20 continuously from the flat surface 21, the powder material 9 moves toward the center of the tip surface 7 along the scroll groove 23 in the holding space 25. As a result, stir of the powder material 9 in the holding space 25 is promoted, making it possible to enhance the effect of friction stir of the powder material 9.

Thus, in Embodiment 2, since it is possible to frictionally stir the powder material 9 while holding the powder material 9 in the holding space 25 formed on the tip surface 7, it is possible to reduce the powder material 9 dispersed around the rotating tool 2 without being frictionally stirred and to frictionally stir the powder material 9 by the rotating tool 2 reliably.

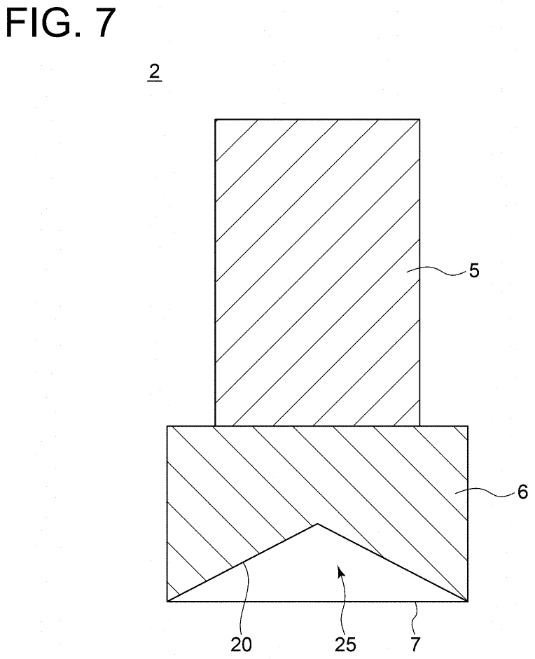

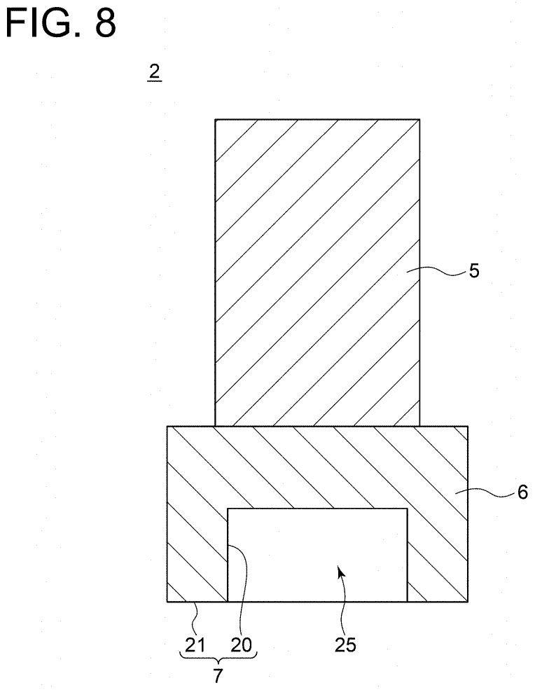

In Embodiment 2, the holding space 25 has the cone shape. However, the present invention is not limited to this shape. The holding space 25 may have any shape capable of holding the powder material 9 and may have, for example, a cone shape as shown in FIG. 7, a columnar shape as shown in FIG. 8, or the like.

In Embodiment 2, the base 8b of the pin 8 is positioned on the recessed surface 20. However, the present invention is not limited to this configuration. The base 8b of the pin 8 may be positioned on the flat surface 21.

### Embodiment 3

Next, an additive manufacturing device and an additive manufacturing method according to Embodiment 3 will be described. The additive manufacturing device and the additive manufacturing method according to Embodiment 3 are obtained by modifying Embodiment 1 in that the rotating tool 2 is surrounded by a guide member. In Embodiment 3, the same constituent elements as those in Embodiment 1 are associated with the same reference numerals and not described again in detail.

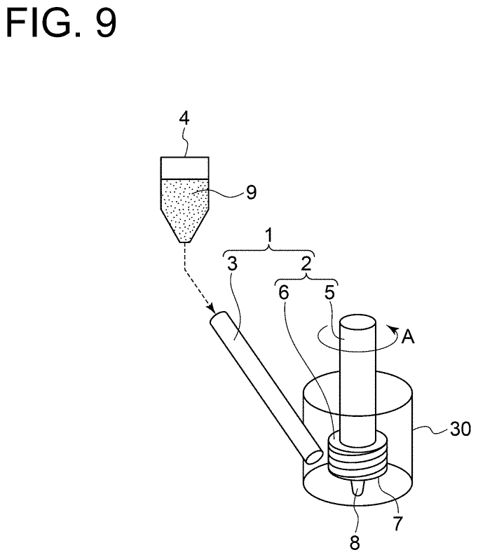

As shown in FIG. 9, the additive manufacturing device 1 according to Embodiment 3 includes the rotating tool 2 disposed to be rotatable, a guide member 30 of a cylindrical shape surrounding the rotating tool 2 along the rotational direction A of the rotating tool 2, and the powder supply nozzle 3 supplying the powder material 9 into the guide member 30.

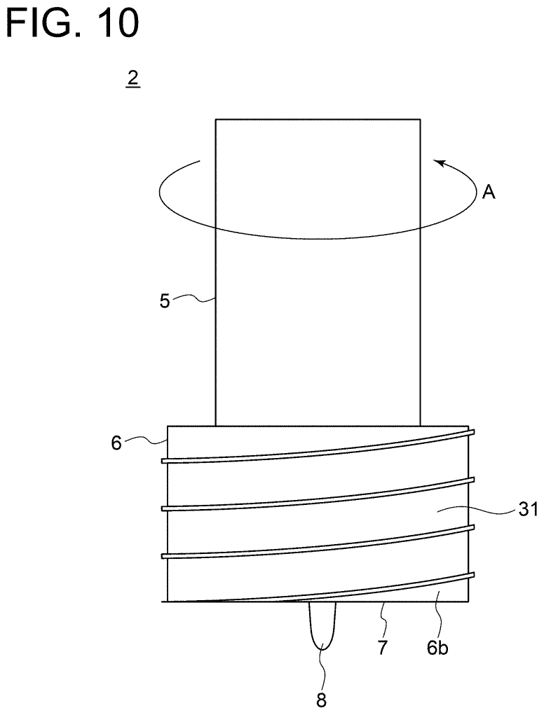

As shown in FIG. 10, the friction stir portion 6 of the rotating tool 2 has an outer surface 6b of a columnar shape. Although not an essential component in Embodiment 3, a spiral groove 31 of a spiral shape may be formed in the outer surface 6b. The spiral groove 31 is preferably formed so as to extend in a direction distanced from the tip surface 7 along the rotational direction A of the rotating tool 2. The spiral groove 31 can be made by forming a recess, that is, a groove extending in a spiral shape in the outer surface 6b or may be made by attaching a member extending in a spiral shape so as to protrude from the outer surface 6b.

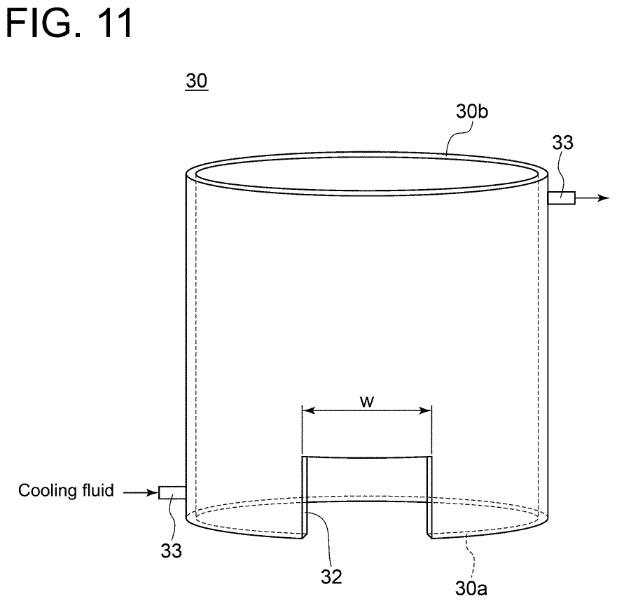

As shown in FIG. 11, the guide member 30 of a columnar shape has a first edge 30a facing the lamination plane 10 (see FIG. 1) and a second edge 30b opposing the first edge 30a. Although not an essential component in Embodiment 3, a cut-out portion 32 cut out from the first edge 30a toward the second edge 30b may be formed in the guide member 30. The cut-out portion 32 has a width w which needs to be larger than the width of the welded portion 12 (See FIG. 1). In addition, although not an essential component in Embodiment 3, a flow passage 33 for flowing a cooling fluid such as cooling water may be formed in the guide member 30. During additive manufacturing, the flow passage 33 communicates with a supply source (not shown) of the cooling fluid.

Other configurations are the same as Embodiment 1.

In Embodiment 3, the principle that the powder material 9 (see FIG. 1) is welded to the lamination plane 10 (see FIG. 1) and the basic part of the additive manufacturing method by the additive manufacturing device 1 are the same as Embodiment 1. Thus, an operation regarding constituent elements included only by the additive manufacturing device 1 of Embodiment 3 and an effect obtained therefrom will be described below.

As shown in FIG. 9, in Embodiment 3, the rotating tool 2 frictionally stirs the powder material 9 supplied into the guide member 30 via the powder supply nozzle 3. Then, with the guide member 30, it is possible to reduce the powder material 9 dispersed around the rotating tool 2 without being frictionally stirred. Thus, the rotating tool 2 can frictionally stir the powder material 9 reliably.

A part of the powder material 9 supplied into the guide member 30 via the powder supply nozzle 3 is positioned between the inner circumferential surface of the guide member 30 and the outer surface 6b of the friction stir portion 6 in the rotating tool 2 (see FIG. 10). Rotating the rotating tool 2 in the direction of the arrow A in this state, the powder material 9 moves along the spiral groove 31 (see FIG. 10) if the spiral groove 31 is formed in the outer surface 6b. If the spiral groove 31 is formed so as to extend in the direction distanced from the tip surface 7 along the rotational direction A of the rotating tool 2, the powder material 9 moves toward the tip surface 7 along the spiral groove 31. As a result, the powder material 9 easily enters between the tip surface 7 and the lamination plane 10 (see FIG. 1), allowing the rotating tool 2 to frictionally stir the powder material 9 reliably.

Moreover, during additive manufacturing by the additive manufacturing device 1, the temperatures of the powder material 9 and the base material 11 (see FIG. 1) increase due to friction heat. As shown in FIG. 11, if the flow passage 33 for flowing the cooling fluid is formed in the guide member 30, the guide member 30 is cooled by the cooling fluid during friction stir. Thus, it is possible to reduce seizure between the rotating tool 2 and the guide member 30.

Furthermore, if the cut-out portion 32 is formed in the guide member 30, the formed welded portion 12 (see FIG. 2) passes through the cut-out portion 32 when the additive manufacturing device 1 (see FIG. 9) moves, making it possible to smoothly move the additive manufacturing device 1 by preventing the guide member 30 from being caught in the welded portion 12.

Thus, in Embodiment 3, since it is possible to reduce, with the guide member 30, the powder material 9 dispersed around the rotating tool 2 without being frictionally stirred, the rotating tool 2 can frictionally stir the powder material 9 reliably.

In each of Embodiments 1 and 3, the thread groove 22 of Embodiment 2 may be formed in the outer peripheral surface 8c of the pin 8, or the scroll groove 23 of Embodiment 2 may be formed in the tip surface 7.

In each of Embodiments 1 to 3, the additive manufacturing device 1 may not include the powder supply nozzle 3. In this case, it is possible to frictionally stir the powder material 9 by the rotating tool 2 after supplying the powder material 9 onto the lamination plane 10 in advance.

### REFERENCE SIGNS LIST

1 Additive manufacturing device
2 Rotating tool
3 Powder supply nozzle (supply member)
4 Storage portion
5 Grip portion
6 Friction stir portion
6b Outer surface (of friction stir portion)
7 Tip surface
7a Outer circumferential edge (of tip surface)
8 Pin
8a Tip (of pin)
8b Base (of pin)
8c Outer peripheral surface (of pin)
9 Powder material
10 Lamination plane
11 Base material
11a Surface (of base material)
12 Welded portion
12a Surface (of welded portion)
20 Recessed surface
21 Flat surface
21a Outer circumferential edge (of flat surface)
22 Thread groove
23 Scroll groove
24 Communication portion
24a Slit
25 Holding space
30 Guide member
30a First edge
30b Second edge
31 Spiral groove
32 Cut-out portion
33 Flow passage

1. An additive manufacturing method for performing additive manufacturing of a metallic powder material on a surface of a metallic base material, comprising:
a step of supplying the powder material onto the surface of the base material;
a step of welding the powder material to the surface in an unmelted state through friction stir of the powder material and the surface by moving a rotatable rotating tool along a direction parallel to the surface while rotating the rotating tool;
a step of supplying the powder material onto a welded portion formed by welding the powder material to the surface; and
a step of welding the powder material to the welded portion in the unmelted state through friction stir of the powder material and the welded portion by moving the rotating tool along the direction parallel to the surface while rotating the rotating tool.

2. The additive manufacturing method according to claim 1,
wherein the powder material is welded to the surface to perform additive manufacturing of an additive manufactured object of a three-dimensional shape protruding with respect to the surface.

3. The additive manufacturing method according to claim 1,
wherein the powder material is welded onto the welded portion through friction stir of the powder material and the welded portion while supplying the powder material to the welded portion.

4. The additive manufacturing method according to claim 1,
wherein the rotating tool includes:
a tip surface where a recessed surface is formed;
a holding space defined by the recessed surface; and
a communication portion making the holding space and an exterior of the rotating tool communicate with each other, and
wherein friction stir is made by rotating the rotating tool while allowing the powder material to flow into the holding space via the communication portion.

5. The additive manufacturing method according to claim 4, further comprising a step of preparing a guide member surrounding the rotating tool along a rotational direction of the rotating tool after the step of preparing the rotating tool.

6. The additive manufacturing method according to claim 5, further comprising a step of preparing a supply member for supplying the powder material before the step of supplying the powder material onto the surface of the base material,
wherein the powder material is supplied into the guide member by the supply member.

7. The additive manufacturing method according to claim 1,
wherein the metal includes aluminum, an aluminum alloy, a nickel-based alloy, an iron-based material, a titanium alloy, a copper alloy, stainless steel, or Inconel.

8. An additive manufacturing device for performing additive manufacturing of a metallic powder material on a metallic lamination plane, comprising:
a rotatable rotating tool,
wherein the rotating tool includes:
a tip surface where a recessed surface is formed; and
a pin disposed so as to protrude more than a part of the tip surface protruding most from the recessed surface, and
wherein the part protruding most from the recessed surface is formed so as to surround the recessed surface.

9. The additive manufacturing device according to claim 8,
wherein, in the rotating tool, a communication portion making a holding space and an exterior of the rotating tool communicate with each other is formed, the holding space being defined by the recessed surface.

10. The additive manufacturing device according to claim 8,
wherein, on the tip surface, a scroll groove of a scroll shape is formed, the scroll groove extending in a direction toward an outer circumferential edge of the tip surface along a rotational direction of the rotating tool.

11. The additive manufacturing device according to claim 8, further comprising a supply member supplying the powder material onto the lamination plane.

12. An additive manufacturing device for performing additive manufacturing of a metallic powder material on a metallic lamination plane, comprising:
a rotatable rotating tool including a tip surface and a pin protruding from the tip surface; and
a guide member surrounding the rotating tool along a rotational direction of the rotating tool,
wherein the rotating tool and the guide member have an interval therebetween.

13. The additive manufacturing device according to claim 12,
wherein the rotating tool has an outer surface of a columnar shape where a spiral groove of a spiral shape is formed, the spiral groove extending in a direction distanced from the tip surface along the rotational direction of the rotating tool.

14. The additive manufacturing device according to claim 12,
wherein the guide member has a first edge facing the lamination plane and a second edge opposing the first edge, and in the guide member, a cut-out portion cut out from the first edge toward the second edge is formed.

15. The additive manufacturing device according to claim 12,
wherein, in the guide member, a flow passage for flowing a cooling fluid is formed.

16. The additive manufacturing device according to claim 12, further comprising a supply member for supplying the powder material into the guide member.

17. The additive manufacturing device according to claim 8,
wherein a thread groove is formed in an outer peripheral surface of the pin, the thread groove extending from a base toward a tip of the pin along a rotational direction of the rotating tool.

18. The additive manufacturing device according to claim 12,
wherein a thread groove is formed in an outer peripheral surface of the pin, the thread groove extending from a base toward a tip of the pin along the rotational direction of the rotating tool.

19. The additive manufacturing method according to claim 1,
wherein a guide member surrounding the rotating tool along a rotational direction of the rotating tool is provided, and
wherein the step of welding the powder material to the surface and the step of welding the powder material to the welded portion are respectively performed while cooling the guide member.
